(19) United States
(12) Patent Application Publication
(10) Pub. No.: US 2025/0305578 A1
(43) Pub. Date: Oct. 2, 2025

(54) CONTROL APPARATUS FOR VEHICLE

(71) Applicant: TOYOTA JIDOSHA KABUSHIKI KAISHA, Toyota-shi (JP)

(72) Inventors: Kenji IGAWA, Sunto-gun (JP); Hiroyuki TANAKA, Mishima-shi (JP); Akira IJICHI, Odawara-shi (JP)

(73) Assignee: TOYOTA JIDOSHA KABUSHIKI KAISHA, Toyota-shi (JP)

(21) Appl. No.: 19/081,751

(22) Filed: Mar. 17, 2025

(30) Foreign Application Priority Data
Mar. 29, 2024 (JP) 2024-057465

(51) Int. Cl. F16H 61/12; B60K 35/22; B60K 35/28; F16H 59/02; F16H 59/04; G07C 5/08

(52) U.S. Cl. CPC F16H 61/12; B60K 35/22; B60K 35/28; F16H 59/044; G07C 5/0825; B60K 2360/162; B60K 2360/178; F16H 59/0204; F16H 2061/1256

(57) ABSTRACT

A control apparatus for a vehicle that includes (i) a power source, (ii) a drive wheel and (iii) a transmission. The transmission includes an actuator and a dog clutch which includes meshing teeth and which is to be placed in an engaged state by engagement of the meshing teeth and is to be placed in a disengaged state by releasing the engagement, such that a gear stage of the transmission is automatically changed by the actuator that is operated in accordance with a manual gear shift operation. The control apparatus is configured to determine whether or not a failure of the engagement occurs when the gear shift operation is performed, and is configured, when determining that the failure of the engagement occurs, to notify occurrence of the failure of the engagement and information about a procedure that is to be taken for dealing with the failure of the engagement.

This application claims priority from Japanese Patent Application No. 2024-057465 filed on Mar. 29, 2024, the disclosure of which is herein incorporated by reference in its entirety.

### FIELD OF THE INVENTION

The present invention relates to a control apparatus for a vehicle including a transmission in which a gear stage is changed by switching an operation state of a dog clutch.

### BACKGROUND OF THE INVENTION

There is well-known a control apparatus for a vehicle that includes a power source, a drive wheel and a transmission configured to transmit a power of the power source to the drive wheel, wherein the transmission includes an actuator and a dog clutch which is to be placed in an engaged state by engagement of meshing teeth and is to be placed in a disengaged state by releasing the engagement, such that a gear stage of the transmission is automatically changed by the actuator that is operated to switch the dog clutch between the engaged state and the disengaged state in accordance with a manual gear shift operation. For example, a control apparatus for a vehicle transmission described in Patent Document 1 is such a control apparatus. Patent Document 1 discloses a technique for determining whether or not a top-surface stop state in which meshing teeth are not meshed with each other due to abutment of their top surfaces, namely, an engagement failure in which the dog clutch cannot be switched to the engaged state, has occurred.

### PRIOR ART DOCUMENT

### Patent Document

### [Patent Document 1]

Japanese Patent Application Laid-Open No. 2023-22531

### SUMMARY OF THE INVENTION

When a maintenance work or the like is performed in a state where a vehicle driver, a maintenance worker or the like is not informed of occurrence of an failure of engagement between meshing teeth in the dog clutch, durability of the dog clutch could be reduced due to damage of the meshing teeth or the like. Further, there is a possibility that the maintenance worker or the like does not know a next procedure to be taken upon occurrence of the failure of the engagement. Note that the failure of the engagement between the meshing teeth in the dog clutch, namely, the engagement failure of the dog clutch includes an engagement failure in which the dog clutch cannot be switched to the engaged state and an engagement failure in which the dog clutch cannot be switched to the disengaged state.

The present invention has been made in view of the above circumstances, and an object of the present invention is to provide a control apparatus for a vehicle, wherein the control apparatus is capable of avoiding or suppressing reduction of durability of a dog clutch and improving workability of maintenance, even where an engagement failure of the dog clutch occurs.

The present invention provides a control apparatus for a vehicle that includes (i) a power source, (ii) a drive wheel and (iii) a transmission configured to transmit a power of the power source to the drive wheel, wherein the transmission includes an actuator and a dog clutch which includes meshing teeth and which is to be placed in an engaged state by engagement of the meshing teeth and is to be placed in a disengaged state by releasing the engagement, such that a gear stage of the transmission is automatically changed by the actuator that is operated to switch the dog clutch between the engaged state and the disengaged state in accordance with a manual gear shift operation. The control apparatus incudes a processor which is configured to determine whether or not a failure of the engagement occurs when the gear shift operation is performed, and which is configured, when determining that the failure of the engagement occurs, to notify occurrence of the failure of the engagement and information about a procedure that is to be taken for dealing with the failure of the engagement.

In the control apparatus according to the invention, when the gear shift operation is performed, it is determined whether or not the engagement failure of the dog clutch occurs, and when it is determined that the engagement failure occurs, notification of the occurrence of the engagement failure and information about the predetermined procedure for dealing with the engagement failure is made. This allows a driver of the vehicle, a maintenance worker or the like to recognize the engagement failure. Further, elimination of the engagement failure is promoted, so that the engagement failure is easily eliminated. Therefore, even when the engagement failure of the dog clutch occurs, it is possible to avoid or suppress reduction of the durability of the dog clutch and to improve the workability of maintenance.

### BRIEF DESCRIPTION OF THE DRAWINGS

FIG. 1 is a view schematically showing a construction of a vehicle to which the present invention is applied.

FIG. 2 is a view for explaining control functions and main parts of a control system for various controls in the vehicle.

FIG. 3 is a flowchart showing a main part of a control operation of an electronic control apparatus, namely, a control routine that is executed by the electronic control apparatus, for avoiding or suppressing reduction of durability of a dog clutch and improving workability of maintenance even where an engagement failure of the dog clutch occurs.

### DETAILED DESCRIPTION OF PREFERRED EMBODIMENT

Hereinafter, an embodiment of the present invention will be described in detail with reference to the drawings.

### Embodiment

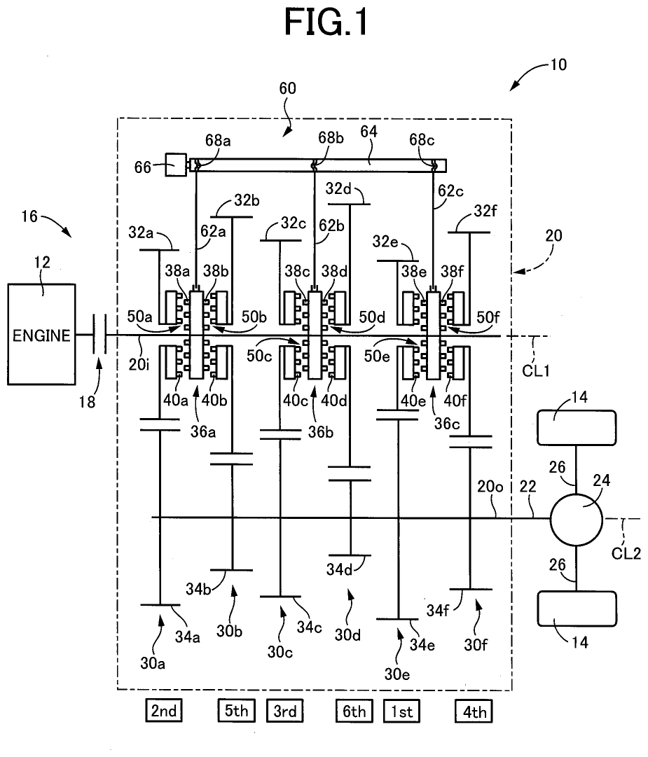

FIG. 1 is a view schematically showing a construction of a vehicle 10 to which the present invention is applied. In FIG. 1, the vehicle 10 includes an engine 12 that functions as a power source, drive wheels 14 and a power transmission device 16 that is provided in a power transmission path between the engine 12 and the drive wheels 14.

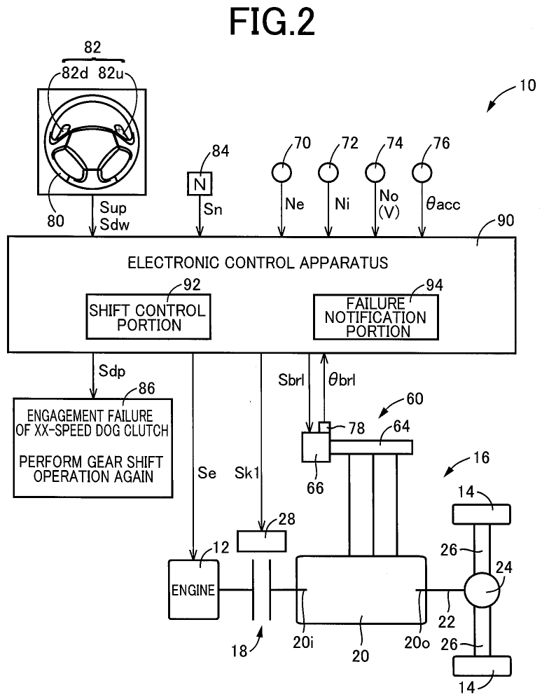

The engine 12 is, for example, a known internal combustion engine. An electronic control apparatus 90 (see FIG. 2), which will be described later, controls a throttle actuator, a fuel injection device, an ignition device and the like provided in the vehicle 10, such that an engine torque Te, which is a torque of the engine 12, is controlled.

The power transmission device 16 includes a K1 clutch 18 and a transmission 20 that transmits a power of the engine 12 to the drive wheels 14. The power transmission device 16 includes a propeller shaft 22 connected to an output shaft 200, a differential gear device 24 connected to the propeller shaft 22 and a pair of drive shafts 26 connected to the differential gear device 24. The output shaft 200 is an output rotary member of the transmission 20.

The K1 clutch 18 is provided between the engine 12 and an input shaft 20i. The input shaft 20i is an input rotary member of the transmission 20. The K1 clutch 18 is a hydraulic friction engagement device constituted by, for example, a multi-plate type or single-plate type clutch, and an operation state of the K1 clutch 18 is switched by changing a K1 torque Tk1 by a K1 hydraulic pressure PRk1 supplied from a hydraulic control unit 28 (see FIG. 2) provided in the vehicle 10. The K1 hydraulic pressure PRk1 is a hydraulic pressure regulated by the hydraulic control unit 28. The K1 torque Tk1 is a torque capacity of the K1 clutch 18. The operation state is a control state such as an engagement state, a slip state or a release state.

In the vehicle 10, when the K1 clutch 18 is in the engaged state, the engine 12 and the transmission 20 are connected to each other in a power transmittable manner. On the other hand, when the K1 clutch 18 is in the disengaged state, power transmission between the engine 12 and the transmission 20 is interrupted. The K1 clutch 18 functions as a clutch that connects and disconnects the power transmission between the engine 12 and the transmission 20. In the power transmission device 16, when the K1 clutch 18 is in the engaged state, the power outputted from the engine 12 is transmitted to the drive wheels 14 sequentially via the K1 clutch 18, the transmission 20, the propeller shaft 22, the differential gear device 24, the drive shafts 26 and the like.

The transmission 20 includes a plurality of rotary shafts in form of the above-described input and output shafts 20i, 20o that are arranged in parallel to each other. The transmission 20 is a so-called parallel-two-shaft-type transmission in which a plurality of gear positions (also referred to as shift positions) are established by reducing or increasing a rotation of the input shaft 20i at predetermined gear ratios (also referred to as speed ratios) δ(=Ni/No). “Ni” is an input rotational speed Ni of the transmission 20, and is a rotational speed of the input shaft 20i. “No” is an output rotational speed No of the transmission 20, and is a rotational speed of the output shaft 200. The input shaft 20i is disposed rotatably about a rotation axis CL1. The driven shaft 200 is disposed rotatably about a rotation axis CL2.

The transmission 20 includes a plurality of pairs of gears 30, wherein each pair of gears 30 constantly mesh with each other. The pairs of gears 30 include a second-speed gear pair 30a, a fifth-speed gear pair 30b, a third-speed gear pair 30c, a sixth-speed gear pair 30d, a first-speed gear pair 30e and a fourth-speed gear pair 30f that are arranged in this order of description as seen in a direction of the rotation axis CL1 away from the engine 12 toward the drive wheels 14. The direction of the rotation axis CL1 is synonymous with an axial direction of the input shaft 20i.

The plurality of pairs of gears 30 are is constituted by a plurality of drive gears 32 and a plurality of driven gears 34. Each one of the drive gears 32 and a corresponding one of the driven gears 34 constantly mesh with each other. The drive gears 32 include a second-speed drive gear 32a, a fifth-speed drive gear 32b, a third-speed drive gear 32c, a sixth-speed drive gear 32d, a first-speed drive gear 32e and a fourth-speed drive gear 32f. The driven gears 34 include a second-speed driven gear 34a, a fifth-speed driven gear 34b, a third-speed driven gear 34c, a sixth-speed driven gear 34d, a first-speed driven gear 34e and a fourth-speed driven gear 34f.

The drive gears 32 are provided so as to be rotatable relative to the input shaft 20i. The driven gears 34 is fixed to the output-shaft 20o so as not to be rotatable relative to the output-shaft 20o. When the drive gears 32 are rotated, the driven gears 34 and the driven shaft 20o are rotated at a rotational speed corresponding to the gear ratio δ of the pairs of gears 30.

The transmission 20 includes switching mechanisms 36 disposed on the input shaft 20i. The switching mechanisms 36 include a first switching mechanism 36a, a second switching mechanism 36b and a third switching mechanism 36c. The first switching mechanism 36a is disposed in a position between the second-speed drive gear 32a and the fifth-speed drive gear 32b and adjacent to the second-speed drive gear 32a and the fifth-speed drive gear 32b in the direction of the rotation axis CL1. The second switching mechanism 36b is disposed in a position between the third-speed drive gear 32c and the sixth-speed drive gear 32d and adjacent to the third-speed drive gear 32c and the sixth-speed drive gear 32d in the direction of the rotation axis CL1. The third switching mechanism 36c is disposed in a position between the first-speed drive gear 32e and the fourth-speed drive gear 32f and adjacent to the first-speed drive gear 32e and the fourth-speed drive gear 32f in the direction of the rotation axis CL1.

Each of the switching mechanisms 36 switches a power transmission state of the corresponding pairs of gears 30 between a power transmittable state and a power non-transmittable state. Each of the switching mechanisms 36 is a connecting/disconnecting device configured to switch between at least two states. In one of the two states, one of two adjacent drive gears 32, which are located on opposite sides of each of the switching mechanisms 36 in the direction of the rotation axis CL1, is connected to the input shaft 20i so as to be unrotatable relative to the input shaft 20i, while another one of the two adjacent drive gears 32 is disconnected from the input shaft 20i so as to be rotatable relative to the input shaft 20i. In another one of the two states, the one of the two adjacent drive gears 32 is disconnected from the input shaft 20i so as to be rotatable relative to the input shaft 20i, while the other one of the two adjacent drive gears 32 is connected to the input shaft 20i so as to be unrotatable relative to the input shaft 20i.

For example, when the second-speed drive gear 32a and the input shaft 20i are connected to each other through the first switching mechanism 36a, the second-speed gear pair 30a is placed in the power transmittable state whereby a second-speed gear position 2nd is established in the transmission 20. When the fifth-speed drive gear 32b and the input shaft 20i are connected to each other through the first switching mechanism 36a, the fifth-speed gear pair 30b is placed in the power transmittable state whereby a fifth-speed gear position 5th is established in the transmission 20. The same applies to a third-speed gear position 3rd, a sixth-speed gear position 6th, a first-speed gear position 1st and a fourth-speed gear position 4th.

The switching mechanisms 36 are provided with switching meshing teeth 38 in positions facing toward the drive gears 32 in the direction of the rotation axis CL1. The drive gears 32 are provided with gear-side meshing teeth 40 capable of being engaged with the switching meshing teeth 38 in positions facing toward the switching mechanisms 36 in the direction of the rotation axis CL1. The switching meshing teeth 38 include second-speed switching meshing teeth 38a, fifth-speed switching meshing teeth 38b, third-speed switching meshing teeth 38c, sixth-speed switching meshing teeth 38d, first-speed switching meshing teeth 38e and fourth-speed switching meshing teeth 38f. The gear-side meshing teeth 40 include second-speed-gear-side meshing teeth 40a, fifth-speed-gear-side meshing teeth 40b, third-speed-gear-side meshing teeth 40c, sixth-speed-gear-side meshing teeth 40d, first-speed-gear-side meshing teeth 40e, and fourth-speed-gear-side meshing teeth 40f.

For example, the second-speed switching meshing teeth 38a are switching meshing teeth 38 that are provided in a position facing toward the second-speed drive gear 32a in the direction of the rotation axis CL1 in the first switching mechanism 32a. The same applies to the switching meshing teeth 38 other than the second-speed switching meshing teeth 38a. The second-speed-gear-side meshing teeth 40a are gear-side meshing teeth 40 that are provided in the second-speed drive gear 32a in a position facing toward the first switching mechanism 36a in the direction of the rotation axis CL1 and can mesh with the second-speed switching meshing teeth 38a. The same applies to the gear-side meshing teeth 40 other than the second-speed-gear-side meshing teeth 40a.

The transmission 20 is a dog transmission having dog clutches 50. Each of the dog clutches 50 is a dog clutch that is constituted by a corresponding one of the switching mechanisms 36 including the switching meshing teeth 38, the gear-side meshing teeth 40 and the like. The switching meshing teeth 38 and the gear-side meshing teeth 40 are meshing teeth that constitute a part of each of the dog clutches 50, i.e., meshing teeth. Each of the dog clutches 50 is placed in an engaged state by engagement of meshing teeth with each other, and is placed in a disengaged state by releasing the engagement.

The dog clutches 50 include a second-speed dog clutch 50a, a fifth-speed dog clutch 50b, a third-speed dog clutch 50c, a sixth-speed dog clutch 50d, a first-speed dog clutch 50e and a fourth-speed dog clutch 50f. For example, the second speed dog clutch 50a is constituted by the first switching mechanism 38a including the second speed switching meshing teeth 36a, the second speed gear-side meshing teeth 40a, and the like. The same applies to the dog clutches 50 other than the second speed dog clutch 50a.

The transmission 20 is to be placed in a selected one of six forward gear positions, i.e., the first through sixth gear positions 1st-6th, namely, a gear stage of the transmission 20 is automatically changed with the switching mechanisms 36 being operated. Each of the switching mechanisms 36 is operated by being moved in the direction of the rotation axis CL1. Each of the switching mechanisms 36 is moved in the direction of the rotation axis CL1 by a shift mechanism 60 provided in the transmission 20.

The shift mechanism 60 serves as an actuator for moving the switching mechanisms 36 in the direction of the rotation axis CL1. The shift mechanism 60 includes shift forks 62, a shift barrel 64 and a shift actuator 66. The shift forks 62 include a first shift fork 36a fixed to the first switching mechanism 62a, a second shift fork 36b fixed to the second switching mechanism 62b and a third shift fork 36c fixed to the third switching mechanism 62c. The shift barrel 64 is provided with shift grooves 68 each of which defines a movement path of the switching mechanism 36 in the direction of the rotation axis CLI through the shift fork 62. The shift grooves 68 include a first shift groove 68a, a second shift groove 68b and a third shift groove 68c. For example, the first shift groove 68a defines the movement path of the first switching mechanism 62a in the direction of the rotation axis 36a through the first shift fork CL1. The same applies to the second shift groove 68b and the third shift groove 68c. The shift actuator 66 is an actuator that rotates the shift barrel 64.

Each of the shift grooves 68 extends generally in a circumferential direction of the shift barrel 64, and includes bent portions that are bent to extend in an axial direction of the shift barrel 64. Therefore, when the shift barrel 64 is rotated, each of the shift forks 62 is moved in the axial direction of the shift barrel 64 along a shape of a corresponding one of the shift grooves 68. When each of the shift forks 62 is moved in the axial direction of the shift barrel 64, a corresponding one of the switching mechanisms 36 is moved in the direction of the rotation axis CL1 together with a corresponding one of the shift forks 62.

The shift grooves 68 are different in positions of the bent portions in the circumferential direction of the shift barrel 64. The shift grooves 68 are shaped such that the transmission 20 is sequentially upshifted from the first-speed gear position 1st to the sixth-speed gear position 6th as the shift barrel 64 is rotated in one of opposite directions, and such that the transmission 20 is sequentially downshifted from the sixth-speed gear position 6th to the first-speed gear position 1st as the shift barrel 64 is rotated in the other of the opposite directions.

Further, each of the shift grooves 68 is shaped such that a corresponding one of the switching mechanisms 36 is moved in the direction of the rotation axis CL1 at an appropriate timing, namely, a shift stroke progresses at an appropriate timing, in a transition period of the up-shift and the down-shift. Therefore, each of the switching mechanisms 36 is moved to a predetermined position in the direction of the rotation axis CL1 in accordance with the rotation of the shift barrel 64, whereby an operation state of each of the dog clutches 50 is switched so as to shift the gear. The operation state of each of the dog clutches 50 includes a connected state in which power transmission between a corresponding one of the drive gears 32 and the input shaft 20i is enabled, and a disconnected state in which power transmission between the corresponding one of the drive gears 32 and the input shaft 20i is disengaged. The connected state of each of the dog clutches 50 is synonymous with an engaged state of each of the dog clutches 50, and the disconnected state of each of the dog clutches 50 is synonymous with a disengaged state of each of the dog clutches 50.

FIG. 2 is a view for explaining control functions and main parts of a control system for various controls in the vehicle 10. As shown in FIG. 2, the vehicle 10 further includes the above-described electronic control apparatus 90 as a controller including a processor related to controls of the engine 12 and the transmission 20. The electronic control apparatus 90 includes a so-called microcomputer including, for example, a CPU, a RAM, a ROM and an input/output interface. The CPU executes various controls of the vehicle 10 by performing signal processing in accordance with programs stored in the ROM in advance while using a temporary storage function of the RAM.

The electronic control apparatus 90 is supplied with various signals based on values detected by various sensors and the like provided in the vehicle 10. The various sensors and the like are, for example, an engine speed sensor 70, an input speed sensor 72, an output speed sensor 74, an accelerator opening-degree sensor 76, a barrel angle sensor 78 and the like. The various signals include, for example, an engine rotational speed Ne, an input rotational speed Ni, an output rotational speed No, an accelerator opening degree θacc and a barrel rotation angle θbrl. The output rotational speed No is a rotational speed corresponding to a running speed V of the vehicle 10. The barrel rotation angle θbrl is a rotation angle of the shift barrel 64.

The vehicle 10 further includes a paddle switch 82 fixed to a steering wheel 80 provided in the vehicle 10. The paddle switch 82 is an input device that receives a manual gear shift operation. The manual gear shift operation includes, for example, an upshift operation for requesting an upshift of the transmission 20 and a downshift operation for requesting a downshift of the transmission 20. Therefore, the paddle switch 82 includes an upshift switch 82u that receives the upshift operation and a downshift switch 82d that receives the downshift operation. The electronic control apparatus 90 is supplied with an upshift request signal Sup for requesting the upshift of the transmission 20 each time the upshift switch 82u is operated. The electronic control apparatus 90 is supplied with a downshift request signal Sdw for requesting the downshift of the transmission 20 each time the downshift switch 82d is operated.

The vehicle 10 further includes a neutral switch 84. The neutral switch 84 is an input device that receives the manual gear shift operation for placing the transmission 20 to a neutral state. The neutral state of the transmission 20 is a state in which none of the gear positions of the transmission 20 is established, namely, a state in which the transmission 20 is placed in a power transmission disabled state. The transmission 20 is placed in the neutral state when all of the dog clutches 50 are placed in the disengaged states. The electronic control apparatus 90 is supplied with a neutral request signal Sn for requesting the neutral state of the transmission 20 every time the neutral switch 84 is operated.

The electronic control apparatus 90 outputs various command signals to the devices provided in the vehicle 10. The devices are, for example, the engine 12, the hydraulic control unit 28, the shift actuator 66, a display 86 and the like. The display 86 is a display device that is provided in the vehicle 10 and displays notification items, guidance and the like. The various command signals are, for example, an engine-control command signal Se, a K1 hydraulic-pressure-control command signal Sk1, a barrel-control command signal Sbrl, a display-control command signal Sdp and the like. The barrel-control command signal Sbrl is a control command signal for rotationally driving the shift barrel 64. The display-control command signal Sdp is a control command signal for controlling display contents of the display 86, for example.

The electronic control apparatus 90 includes a shift control portion 92 in order to execute various controls in the vehicle 10.

When the shift control portion 92 receives the upshift request signal Sup while any one of the gear positions is established, the shift control portion 92 outputs the barrel-control command signal Sbrl for rotationally driving the shift barrel 64 in an upshift direction to upshift the transmission 20, and the outputted barrel-control command signal Sbrl is supplied to the shift actuator 66. Thus, for example, in an upshift from the first-speed gear position 1st to the second-speed gear position 2nd, the first-speed dog clutch 50e is switched from the engaged state to the disengaged state, and the second-speed dog clutch 50a is switched from the disengaged state to the engaged state. The upshift request signal Sup is invalidated while the sixth-gear position 6th is established.

When the shift control portion 92 receives the upshift request signal Sup while the transmission 20 is in the neutral state, the shift control portion 92 outputs the barrel-control command signal Sbrl for establishing the first-speed gear position 1st by rotationally driving the shift barrel 64. Thus, when the gear stage of the transmission 20 is changed from the neutral state to the first-speed gear position 1st, the first-speed dog clutch 50e is changed from the disengaged state to the engaged state. The upshift may include also a switching from the neutral state to the first-speed gear position 1st in the transmission 20.

When the shift control portion 92 receives the downshift request signal Sdw while any one of the gear positions is established, the shift control portion 92 outputs the barrel-control command signal Sbrl for rotationally driving the shift barrel 64 in the downshift direction to downshift the transmission 20, and the outputted barrel-control command signal Sbrl is supplied to the shift actuator 66. Thus, for example, in the downshift from the second-speed gear position 2nd to the first-speed gear position 1st, the second-speed dog clutch 50a is switched from the engaged state to the disengaged state, and the first speed dog clutch 50e is switched from the disengaged state to the engaged state. The downshift request signal Sdw is invalidated while the first-speed gear position 1st is established.

When the shift control portion 92 receives the neutral request signal Sn while any one of the gear positions is established, the shift control portion 92 outputs the barrel-control command signal Sbrl for rotationally driving the shift barrel 64 so as to place the transmission 20 into the neutral state, and the outputted barrel-control command signal Sbrl is supplied to the shift actuator 66. Thus, for example, when the first-speed gear position 1st is switched to the neutral state, the first-speed dog clutch 50e is switched from the engaged state to the disengaged state.

The shift mechanism 60, which serves as the actuator, is operated in accordance with the manual gear shift operation. The transmission 20 automatically switches the gear stage by switching each of the dog clutches 50 between the engaged state and the disengaged state by the shift mechanism 60.

By the way, when the gear stage of the transmission 20 is to be changed, an engagement failure of the corresponding dog clutch 50, namely, a non-engageable state in which the corresponding dog clutch 50 cannot be switched from the disengaged state to the engaged state, may occur due to abutment of top surfaces of the meshing teeth. Further, when the gear stage of the transmission 20 is to be changed, another engagement failure of the corresponding dog clutch 50, namely, a non-disengageable state in which the corresponding dog clutch 50 cannot be switched from the engaged state to the disengaged state, may occur whereby the transmission 20 cannot be placed into the neutral state, for example. If a maintenance work or the like is performed without noticing the engagement failure of the dog clutch 50, the meshing teeth of the dog clutch 50 could be damaged, or the drive wheels 14 could be idled in the vehicle 10 that is stopped in a floating state. Further, an appropriate operation or procedure to be taken for dealing with the engagement failure of the dog clutch 50 is not known, and there is a possibility that the engagement failure cannot be promptly eliminated. The floating state of the vehicle 10 is synonymous with a state in which the drive wheels 14 are not in contact with a ground.

Therefore, the electronic control apparatus 90 further includes an failure notification portion 94 in order to realize a control function of avoiding or suppressing reduction of the durability of the dog clutch 50 or improving the workability of maintenance even when the engagement failure of the dog clutch 50 occurs.

The failure notification portion 94 determines whether or not the engagement failure of each of the dog clutches 50 has occurred, for example, when the manual gear shift operation is performed through the paddle switch 82 or the neutral switch 84. For example, the failure notification portion 94 determines whether or not the engagement failure of each of the dog clutches 50 has occurred, depending on whether or not an actual barrel rotation angle θbrlr coincides with a predetermined barrel rotation angle θbrlf that is to be realized by the manual gear shift operation. The predetermined barrel rotation angle θbrlf is, for example, a predetermined barrel rotation angle θbrl in a gear stage (including a neutral state) of the transmission 20 to be realized by the manual gear shift operation. The actual barrel rotation angle θbrlr is the barrel rotation angle θbrl detected by the barrel angle sensor 78, and is synonymous with the barrel rotation angle θbrl unless otherwise specified.

When the failure notification portion 94 determines that the engagement failure of any one of the dog clutches 50 has occurred at the time of the manual shift operation, the failure notification portion 94 notifies occurrence of the engagement failure of the dog clutch 50 and information about a predetermined procedure Mf that is to be taken for dealing with the engagement failure of the dog clutch 50.

The failure notification portion 94 notifies the occurrence of the engagement failure of the dog clutch 50 and the information about the predetermined procedure Mf for dealing with the engagement failure of the dog clutch 50 by causing the display 86 to display the occurrence of the engagement failure and the information about the predetermined procedure Mf. The failure notification portion 94 outputs a display control command signal Sdp for displaying information of the gear stage (including the neutral state) in which the engagement failure of the corresponding dog clutch 50 has occurred and information of the predetermined procedure Mf, and the outputted display control command signal Sdp is supplied to the display 86. Thus, the provided information is displayed on the display 86, and the information of the predetermined procedure Mf such as a work content for dealing with the engagement failure is notified.

When the failure notification portion 94 determines that the engagement failure of the dog clutch 50 has occurred, the failure notification portion 94 selects the information of the predetermined procedure Mf such as the work content for dealing with the engagement failure, based on a state of the engagement failure of the dog clutch 50.

The engagement failure of the dog clutch 50 is assumed to be, for example, due to the non-engageable state, i.e., a failure in which the dog clutch 50 cannot be switched to the engaged state in response to a shift operation of upshifting or downshifting the transmission 20.

In a case of the non-engageable state with each of the engine 12 and the drive wheels 14 being in the rotation stop state, the dog clutch 50 is easily placed into the engaged state by manually rotating the drive wheel 14. When the vehicle 10 is stopped in the floating state, the drive wheel 14, which is not in contact with the ground, is rotated by being manually moved a little in the rotation direction. Further, when the vehicle 10 is stopped with the drive wheels 14 being in contact with the ground, the drive wheels 14 are rotated with the vehicle 10 being manually moved slightly in a forward/reverse direction. When the engagement failure is the non-engageable state with the rotation stop state of the engine 12 and the rotation stop state of the drive wheels 14, the failure notification portion 94 selects, as the predetermined procedure Mf, to manually rotate the drive wheels 14 while maintaining the rotation stop state of the engine 12.

In a case of the non-engageable state with the engine 12 being in a rotation state, the dog clutch 50 is easily placed into the engaged state by repeating the gear shift operation at that time. In the case of the non-engageable state with the engine 12 being in the rotation state, it is assumed that the vehicle 10 is being stopped while being in the floating state. When the engagement failure is due to the non-engageable state with the engine 12 being in the rotation state, the failure notification portion 94 selects, as the predetermined procedure Mf, to perform the gear shift operation again, wherein the gear shift operation is an operation that was attempted when the non-engageable state was determined.

The engagement failure of the dog clutch 50 is assumed to be, for example, the non-disengageable state, a failure in which the dog clutch 50 cannot be switched to the disengaged state in response to a gear shift operation for placing the transmission 20 into the neutral state. In a case of the non-disengageable state, the dog clutch 50 is easily placed into the disengaged state by repeating the gear shift operation for placing the transmission 20 into the neutral state. For example, when the vehicle 10 is stopped in the floating state, if the engine torque Te is increased for the purpose of warming up the engine 12 or the like in a state in which any one of the gear positions is established in the transmission 20, there is a case in which the accelerator is turned off together with the shift operation for placing the transmission 20 into the neutral state. At this time, the engine torque Te is reduced, and the rotational speed of the drive wheels 14 is reduced. Thus, the dog clutch 50 is easily switched to the disengaged state by repeating the shift operation for placing the transmission 20 into the neutral state. When the engagement failure is due to the non-disengageable state, the failure notification portion 94 selects, as the predetermined procedure Mf, to perform the gear shift operation again, wherein the the gear shift operation is an operation that was attempted for placing the transmission 20 into the neutral state again.

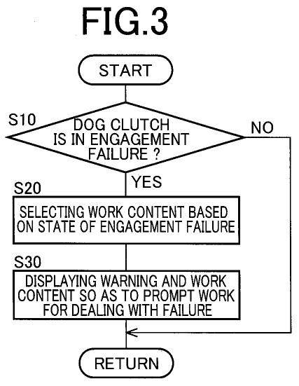

FIG. 3 is a flowchart showing a main part of the control operation of the electronic control apparatus 90, namely, a control routine that is executed by the electronic control apparatus 90, for avoiding or suppressing reduction of durability of the dog clutch 50 and improving workability of maintenance even where the engagement failure of the dog clutch 50 occurs. This control routine is executed in a repeated manner, for example.

Each step of the control routine shown in the flowchart of FIG. 3 corresponds to function of the failure notification portion 94. At step S10, it is determined whether or not any one of the dog clutches 50 is in the engagement failure when the manual gear shift operation is performed. If a negative determination is obtained at step S10, one cycle of execution of the control routine is terminated. When an affirmative determination is made at step S10, step S20 is implemented to select the predetermined procedure Mf for dealing with the engagement failure, based on the state of the engagement failure of the dog clutch 50. Next, at step S30, a warning that the engagement failure has occurred and the work contents as the predetermined procedure Mf for dealing with the engagement failure are displayed on the display 86. The execution of the control routine makes it possible to prompt the work for dealing with the engagement failure.

As described above, in the present embodiment, when it is determined that the engagement failure of the dog clutch 50 has occurred at the time of the gear shift operation, the occurrence of the engagement failure and the information about the predetermined procedure Mf for dealing with the engagement failure are notified. This allows a driver of the vehicle 10, a maintenance worker or the like to recognize the failure of the transmission 20. Further, the elimination of the engagement failure is promoted, so that the engagement failure is easily eliminated. Therefore, even when the engagement failure of the dog clutch 50 occurs, it is possible to avoid or suppress reduction of the durability of the dog clutch 50 and to improve the workability of maintenance. As an auxiliary effect, the safety of the maintenance work can be improved.

In the present embodiment, when the engagement failure is due to the non-engageable state with each of the engine 12 and the drive wheels 14 being in the rotation stop state, the predetermined procedure Mf is to manually rotate the drive wheels 14 while maintaining the rotation stop state of the engine 12. This allows the driver, the maintenance worker or the like to recognize the non-engageable state of the transmission 20. Further, recovery from the non-engageable state is promoted, and the non-engageable state is easily resolved.

In the present embodiment, when the engagement failure is due to the non-engageable state with the engine 12 being in the rotation state, the predetermined procedure Mf is to perform the gear shift operation again, wherein the gear shift operation is an operation that was attempted when the non-engageable state was determined. This allows the driver, the maintenance worker or the like to recognize the non-engageable state of the transmission 20. Further, recovery from the non-engageable state is promoted, and the non-engageable state is easily resolved.

In the present embodiment, when the engagement failure is due to the non-disengageable state, the predetermined procedure Mf is to perform the gear shift operation for placing the transmission 20 into the neutral state again. Thus, the driver, the maintenance worker or the like can recognize the non-disengageable state of the transmission 20. In addition, recovery from the non-disengageable state is promoted, and the non-disengageable state is easily resolved.

In the present embodiment, the occurrence of the engagement failure of the dog clutch 50 and the information about the predetermined procedure Mf are notified by being displayed on the display 86. Thus, the driver, the maintenance worker or the like can appropriately recognize the failure of the transmission 20. Further, the elimination of the engagement failure is promoted, and the engagement failure is easily eliminated.

Although the embodiment of the present invention has been described in detail with reference to the drawings, the present invention is also applicable to other embodiments.

For example, in the above-described embodiment, the engine 12 is exemplified as the power source, but the present invention is not limited to this example. For example, an electric motor may be used as the power source in addition to or place of the engine 12.

In the above-described embodiment, the parallel-two-shaft-type transmission is exemplified as the transmission 20 configured to transmit the power of the power source of the drive wheels 14. However, the present invention is not limited to this example, as long as the gear stage of the transmission is automatically changed by the actuator that is operated to switch each of the dog clutches between the engaged state and the disengaged state in accordance with the manual gear shift operation.

In the above-described embodiment, the display 86 provided in the vehicle 10 is exemplified as the display device that is caused to display the occurrence of the engagement failure and the information about the predetermined procedure Mf. However, the present invention is not limited to this example. For example, the display device may be a display of a portable terminal device which is to be brought into a cabin of the vehicle 10 and which is configured to obtain various kinds of information of the vehicle 10 in a wired or wireless manner. The portable terminal device does not have to be necessarily brought into the cabin of the vehicle 10, and may be used outside the cabin of the vehicle 10.

In the above-described embodiment, the occurrence of the engagement failure and the information about the predetermined procedure Mf are notified by being displayed on the display 86, but the present invention is not limited to this example. The occurrence of the engagement failure and the information about the predetermined procedure Mf may be notified by outputting a voice or the like. In short, it is only necessary to notify that the engagement failure occurs and the information about the predetermined procedure Mf.

In the above-described embodiment, whether or not the engagement failure occurs is determined using the barrel rotation angle Obrl by the barrel angle sensor 78. However, for example, it may be determined whether or not the engagement failure occurs by using a signal from a sensor that detects an amount of movement of each switching mechanism 36 in the direction of the rotation axis CL1.

The above description is merely one embodiment, and the present invention can be implemented in a mode in which various modifications and improvements are added based on the knowledge of those skilled in the art.

### NOMENCLATURE OF ELEMENTS

10: vehicle
12: engine (power source)
14: driving wheel
20: transmission
38: switching meshing tooth (meshing tooth)
40: gear-side meshing tooth (meshing tooth)
50: dog clutch
60: shift mechanism (actuator)
86: display (display device)
90: electronic control apparatus (control apparatus)
94: failure notification portion (processor)

What is claimed is:

1. A control apparatus for a vehicle that includes (i) a power source, (ii) a drive wheel and (iii) a transmission configured to transmit a power of the power source to the drive wheel, wherein the transmission includes an actuator and a dog clutch which includes meshing teeth and which is to be placed in an engaged state by engagement of the meshing teeth and is to be placed in a disengaged state by releasing the engagement, such that a gear stage of the transmission is automatically changed by the actuator that is operated to switch the dog clutch between the engaged state and the disengaged state in accordance with a manual gear shift operation,
the control apparatus comprising a processor which is configured to determine whether or not a failure of the engagement occurs when the gear shift operation is performed, and which is configured, when determining that the failure of the engagement occurs, to notify occurrence of the failure of the engagement and information about a procedure that is to be taken for dealing with the failure of the engagement.

2. The control apparatus according to claim 1,
wherein, when the failure of the engagement is a failure in which the dog clutch cannot be placed to the engaged state from the disengaged state in response to the gear shift operation requesting upshift or downshift of the transmission, with each of the power source and the drive wheel being in a rotation stop state, the processor is configured to select, as the procedure, to manually rotate the drive wheel while maintaining the rotation stop state of the power source.

3. The control apparatus according to claim 1,
wherein, when the failure of the engagement is a failure in which the dog clutch cannot be placed to the engaged state from the disengaged state in response to the gear shift operation requesting upshift or downshift of the transmission, with the power source being in a rotation state, the processor is configured to select, as the procedure, to perform the gear shift operation again.

4. The control apparatus according to claim 1,
wherein, when the failure of the engagement is a failure in which the dog clutch cannot be placed to the disengaged state from the engaged state in response to the gear shift operation requesting the transmission to be placed in a neutral state, the processor is configured to select, as the procedure, to perform the gear shift operation again.

5. The control apparatus according to claim 1,
wherein the processor is configured to notify the occurrence of the failure of the engagement and the information about the procedure, by causing a display device to display the occurrence of the failure and the information about the procedure.
